(19) United States
(12) Patent Application Publication
(10) Pub. No.: US 2010/0158010 A1
(43) Pub. Date: Jun. 24, 2010

(54) METHOD FOR FORWARDING PACKET IN MPLS L3VPN

(75) Inventors: Hyun Joo KANG, Daejeon (KR); Yoon Young AN, Daejeon (KR); Boo Geum Jung, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/626,148

(22) Filed: Nov. 25, 2009

(30) Foreign Application Priority Data
Dec. 22, 2008 (KR) 10-2008-0131729

(51) Int. Cl. H04L 12/56

(52) U.S. Cl. 370/392

(57) ABSTRACT

The present invention relates to a method for forwarding a packet which is to provide a VPN service using an IPv4 address in an MPLS network. The method for forwarding the packet according to the present invention extracts routing information including a VRF identifier from a packet, when the packet is received at one or more CE routers in the MPLS network, searches for next hop information in a forwarding table by using the VRF identifier and a prefix, substitutes the searched next hop information by destination information of the received packet, and transmits the packet to an output port. According to the present invention, since the plurality of forwarding tables for providing the VPN are provided without extending a memory, the packet forwarding can be stably performed.

### CROSS-REFERENCE TO RELATED APPLICATION

This application claims the benefit of Korean Application No. 10-2008-0131729, filed on Dec. 22, 2008 in the Korean Intellectual Property Office, the disclosure of which is incorporated by reference.

### BACKGROUND OF THE INVENTION

1. Field of the Invention

The present invention relates to a method for forwarding a packet for a Virtual Private Network (VPN) service using an IPv4 address in a Multi Protocol Label Switching (MPLS) network.

2. Description of the Related Art

Until the present, enterprise subscribers have hired a private circuit from a telecommunication operator and built an own WAN so as to use an independent network for security and quality assurance, which is called a private network. As various kinds of virtual circuits replace the private circuit, the private network is called a VPN.

However, hiring the private circuit and building the private network has disadvantages such as a very high cost and low network efficiency. Therefore, suggested is an MPLS-based VPN technology which is economical by using a public network instead of using a private circuit, and which can employ traffic management and quality management functions of the MPLS. The MPLS VPN can construct the VPN on a common internet by the connection-oriented MPLS technology.

Meanwhile, the VPN can be implemented into a few methods, such as IP Security (IPSec), Secure Socket Layer VPN (SSL), MPLS L2VPN and MPLS L3VPN. Particularly, the IPSec or SSL, which is a method implemented on the user side, is performed in a network like general data transmission. The MPLS L2VPN and the MPLS L3VPN are methods for providing the VPN on the telecommunication operator side, i.e., in a network, so that users can use a service without special application authentication or user identification. Although the MPLS L3VPN can provide more VPNs than the MPLS L2VPN, basically, both the MPLS L2VPN and the MPLS L3VPN have an advantage of providing the VPN on the network side.

However, in order to provide such an MPLS L3VPN function, a router must manage virtual route information in a plural number, and a forwarding table must exist in a plural number. Accordingly, since a large volume of memory region is needed, there may be a problem in extensibility.

### SUMMARY OF THE INVENTION

Therefore, an object of the present invention is to provide a method for forwarding a packet which performs packet forwarding, supporting a plurality of forwarding tables, without making a lot of modifications to a limited memory and an existing code, so as to add an MPLS L3VPN function to an existing router.

A method for forwarding a packet according to the present invention for achieving the above object includes: receiving a packet at one or more Customer Edge (CE) routers in an MPLS network; extracting routing information including a Virtual Routing and Forwarding (VRF) identifier from the packet; searching for next hop information in a forwarding table by using the VRF identifier and a prefix; and substituting the next hop information searched for in the forwarding table by destination information of the packet, and transmitting the packet to an output port.

In addition, the forwarding table may include a VRF identification table for storing an index corresponding to the VRF identifier.

### BRIEF DESCRIPTION OF THE DRAWINGS

The above and other objects, features and advantages of the present invention will become more apparent from the following description of preferred embodiments given in conjunction with the accompanying drawings, in which:

FIG. 1 is a diagram illustrating a configuration of a general MPLS L3VPN;

FIG. 2 is a diagram illustrating a construction of a forwarding table used in a method for forwarding a packet according to the present invention; and

FIG. 3 is a diagram referred to in explaining a method for forwarding a packet according to an exemplary embodiment of the present invention.

### DETAILED DESCRIPTION OF THE INVENTION

Hereinafter, the present invention will be explained in detail with reference to the drawings.

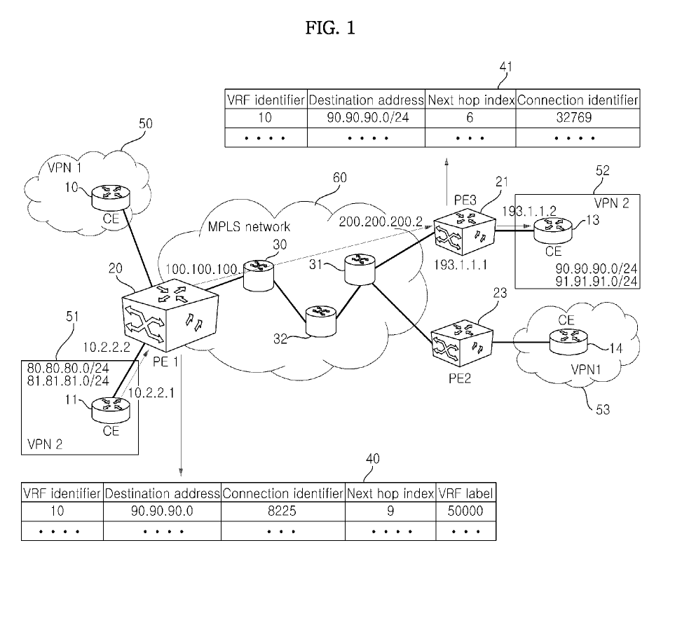

FIG. 1 is a diagram illustrating a configuration of a general MPLS L3VPN. Referring to FIG. 1, VPN1 and VPN2 represent different VPNs, respectively, routers directly connected to a subscriber network are referred to as Provider Edge (PE) routers 20, 21 and 23, and routers connected to the PE routers in the subscriber network for a VPN service are referred to as CE routers 10, 11, 13 and 14.

The respective PE routers 20, 21 and 23 exchange route information of a VPN group by message exchange, and generate and manage a VRF table for the use in transmitting a packet to each VPN group on the basis of the exchanged route information of the VPN group. Therefore, each PE router 20, 21 and 23 has VRF table 1 and VRF table 2 40 and 41 in a plural number. Generally, the VRF table is constructed apart from a general IP routing table, and managed by the PE providing a service to the corresponding VPN group.

Next, a construction of a forwarding table, a process for managing internal data in a forwarding software block, and a method for constructing an H/W memory for forwarding will be explained with respect to implementation of an MPLS L3VPN function.

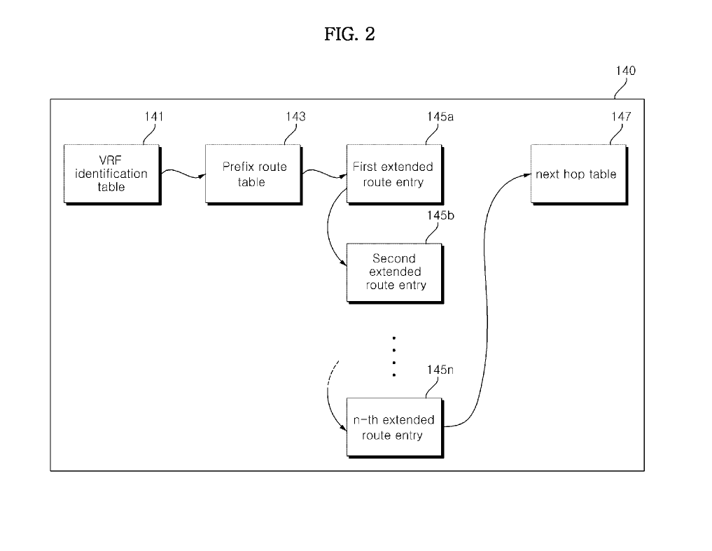

FIG. 2 is a diagram illustrating a construction of a forwarding table used in a forwarding method for an MPLS L3VPN according to an exemplary embodiment of the present invention.

Referring to FIG. 2, the forwarding table used in the method for forwarding the packet according to the present invention includes a VRF identification table 141, a prefix route table 142, first to n-th extended route entries 143a to 143n, and a next hop table 144.

In a router, a forwarding table called a Forwarding Information Base (FIB) is recorded in an H/W memory for H/W forwarding. Unlike an FIB of a general router, to provide the MPLS L3VPN, a VRF must be multiply managed as if a virtual network existed. It may not be easy to extend a new memory.

Accordingly, a VPN identifier VRF-id for a VPN is set in the forwarding table of the present invention, and used in a binary search for longest prefix matching adopted as a route look-up method. That is, the VPN identifier VRF-id, and a prefix which is a front portion of an IP address commonly owned by hosts of the same network are employed as one information in the binary search.

For example, they can be constructed as VRF-id (10 bits)+Prefix (7 bits). Therefore, the VRF identification table 141 and the prefix route table 142 have the beginning information of the binary search. Information succeeding the prefix (7 bits) is recorded in the first extended route entry 143a, and 5 bits can be used as an index of an extended prefix. Information of the n-th extended route entry 143n includes an index of a next hop table 144.

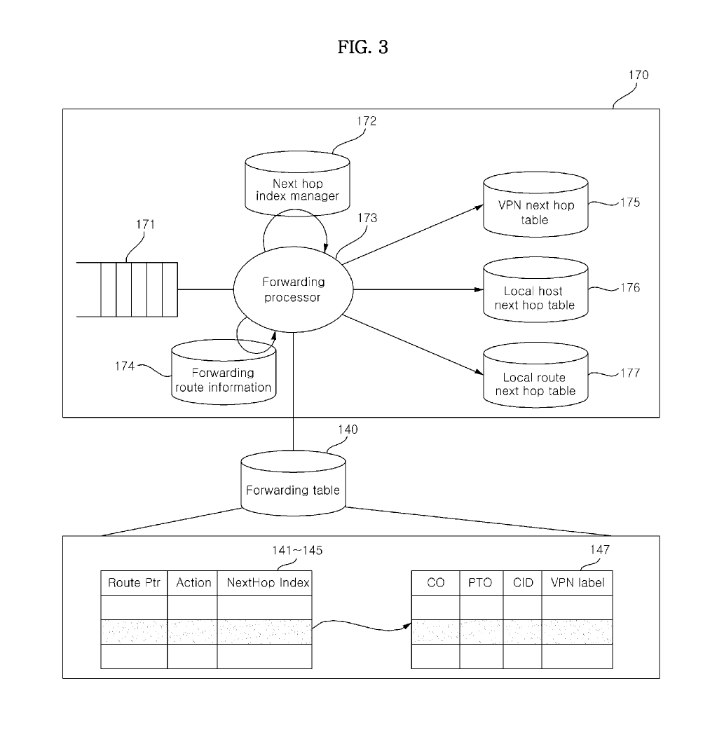

FIG. 3 is a diagram referred to in explaining a method for forwarding a packet according to an exemplary embodiment of the present invention. FIG. 3 shows a process for a software type forwarding processor acquiring forwarding information from a queue (memory), creating a next hop index, and writing a forwarding table in an internal information management structure and an H/W table.

Referring to FIG. 3, the forwarding processor 173 reads forwarding information transferred from a routing software from a forwarding information queue 171. The forwarding processor 173 checks the forwarding information queue 171, stores the forwarding information in a VPN next hop table 175, if it is VPN forwarding information, and stores the forwarding information in a local host next hop table 176 or a local route next hop table 177, if not.

Here, if the input route information already exists in each next hop table, a next hop index is not allocated. However, if the input route information is newly registered information, a next hop index is allocated by a next hop index manager 172, and forwarding route information 174 is updated. In addition, when the new next hop index is allocated, a next hop entry should be made in a forwarding table 140, which is indicated by 144 in FIG. 3. Moreover, when the forwarding route information 174 is updated, a next hop index field is updated in the forwarding table 140.

141 to 143 of the forwarding table 140 can include a route pointer, route operation display (e.g., Drop, Forwarding, Reject, In-to-me, Broadcast, etc.) and a next hop index. The next hop table 144 can include an output card number CO, an output port PTO, a connection identifier CID and a VPN label VPN label. In other words, the next hop table 144 includes the VPN label, which means that VPN identification information is added to a packet at an input end of a router.

Also, when the packet is received, besides the foregoing route look-up process, header verification and header update initialization are carried out. If a header is not verified, the received packet is lost and the look-up is ended.

This process makes it possible to provide the MPLS L3VPN service using a limited memory. In the forwarding method according to the present invention, the construction and method of the exemplary embodiments described above are not limitedly applied, but the whole or parts of each exemplary embodiment may be selectively combined to make various modifications.

In the meantime, the present invention can be implemented into a code readable by a processor in a recording medium readable by the processor. The recording media readable by the processor are all kinds of recording apparatuses for storing data readable by the processor. Exemplary recording media readable by the processor include a ROM, RAM, CD-ROM, magnetic tape, floppy disk, and optical data storing apparatus, and also include an implementation of a carrier wave format such as transmission using an internet. Moreover, the recording media readable by the processor are distributed to computer systems connected through a network, to store and execute the code readable by the processor according to a distribution method.

As discussed earlier, according to the present invention, in order to implement the MPLS L3VPN function in the general router, the plurality of forwarding tables for providing the VPN can be provided without extending the memory. In addition, the next hop table can be extended so that the VPN label for the VPN can be inserted at the input end. Consequently, the packet forwarding can be stably performed in the MPLS network.

While the exemplary embodiments of the present invention have been illustrated in the drawings and described above, the present invention is not limited thereto. It will be apparent to those skilled in the art that various modifications can be made to the described exemplary embodiments without departing from the spirit or scope of the present invention defined by the appended claims.

What is claimed is:

1. A method for forwarding a packet in an MPLS network, the method comprising:
receiving a packet at one or more CE routers;
extracting routing information including a VRF identifier from the packet;
searching for next hop information in a forwarding table by using the VRF identifier and a prefix; and
substituting the next hop information searched for in the forwarding table by destination information of the packet, and transmitting the packet to an output port.

2. The method of claim 1, wherein the forwarding table comprises a VRF identification table storing an index corresponding to the VRF identifier.

3. The method of claim 2, wherein the forwarding table further comprises a prefix route table for storing an index corresponding to the prefix, first to n-th extended route entries for the use in extending the prefix route table, and a next hop table for storing the next hop information.

4. The method of claim 3, wherein the next hop table stores at least one of an output card number, output port, connection identifier and VPN label.

5. The method of claim 1, wherein a binary search for longest prefix matching is used in the search of the forwarding table.

6. The method of claim 1, further comprising verifying a header of the packet.
